(19) United States
(12) Patent Application Publication
(10) Pub. No.: US 2012/0115099 A1
(43) Pub. Date: May 10, 2012

(54) Calciner Gas Distribution Plate Bypass Mechanism

(75) Inventor: Ronald Riddle, Lehighton, PA (US)

(73) Assignee: FLSMIDTH A/S, Valby (DK)

(21) Appl. No.: 12/941,335

(22) Filed: Nov. 8, 2010

(51) Int. Cl. F27B 1/10

(52) U.S. Cl. 432/159

(57) ABSTRACT

A calciner includes a calciner gas distribution plate bypass mechanism. The gas distribution plate bypass mechanism is sized and configured to permit gas to enter a calciner at a temperature below a sticky point of material to be calcined and prevent or substantially reduce material buildup on the gas distribution plate. For instance, additional gas may be introduced into the calciner at a position downstream from the gas distribution plate so that additional gas may be fed into the calciner without passing through the gas distribution plate. The additional mass of gas may allow for increased capacity without elevating the temperature of the gas passing through the gas distribution plate or adjacent to the gas distribution plate and provide sufficient heat for calcining the material. A control damper may be utilized in some embodiments to ensure that certain conditions and operating parameters of the calciner are monitored and maintained.

### FIELD OF INVENTION

The present invention relates to calciners such as suspension calciner systems and kilns.

### BACKGROUND OF THE INVENTION

Calciners are often used as heat transfer devices or kilns. Usually, such devices have fine particles of material, such as zinc or alumina, that are suspended and conveyed in a co-current gas stream and then separated in cyclones. Such devices may be stacked such that the material and gas will become countercurrent between the devices to allow for significant heat recovery, or a more efficient use of the heat in the gas stream. Examples of calciner devices may be appreciated from U.S. Pat. Nos. 5,919,038, 5,260,041, 3,891,383, and 3,871,829.

As may be appreciated from U.S. Pat. No. 5,919,038, calciners often include a grid plate. The grid plate may be a type of air distribution plate or gas distribution plate. Such a plate divides a vessel's upper material chamber and lower plenum chamber. The gas distribution plate usually includes a plurality of holes that are sized and dimensioned to generate a desirable velocity to ensure material suspension. The size of the velocity reduction may also be impacted by the dimensions of the material chamber. The gas distribution plate and the dimensions of the calciner vessel often defines the capacity of a system based on the available flow that can pass through the openings in the gas distribution plate as provided for by equipment used to generate or motivate the gas stream, which is often a hot gas system forced draft fan or an induced draft fan. The temperature of the inlet gas is typically limited by the chemical constrains of the material being processed by the calciner.

In some industries, the feed material to be calcined via a calciner device may contain impurities that soften or melt below the base feed material melting temperature. As a result, the temperature at which such feed material may then be heated may be limited to the softening or “sticky” temperature of the impurities, or an even lower temperature. If the impurity melting temperature is not avoided, then localized buildup may occur on the gas distribution plate. For example, the “sticky” or melted impurity portions of the material may stick to portions of the gas distribution plate and cause buildup of such material on the gas distribution plate. One example of a buildup of material on a gas distribution plate may be appreciated from FIG. 1. Such a buildup of material can prevent even gas distribution and may ultimately require the calciner to be shut down for cleaning of the gas distribution plate or replacement of the gas distribution plate. Such a downtime can take many hours, if not days.

For example, prior to cleaning the gas distribution plate, the temperature of the gas stream must be reduced and then the calciner must be shut down. Further, due to the “sticky” nature of the impurities, the cleaning of the gas distribution plate can be very time consuming. Once the gas distribution plate is cleaned, the gas stream must then be reheated prior to resuming operations. The shutdown of operations that may be caused for cleaning a calciner gas distribution plate is often very undesirable and is often associated with a large cost to the owner of such equipment. Both the energy for heating the gas stream, the extensive time required for the cleaning of the gas distribution plate, and the lost operational time due to the shut down are substantial costs to the owner of such equipment.

Moreover, increased production may result in an elevated hot gas temperature passing through the gas distribution plate to satisfy the production demand. This may cause scaling and increase the rate of material buildup on the gas distribution plate.

A mechanism is needed to substantially reduce the buildup of material on a calciner gas distribution plate. Such a mechanism preferably greatly reduces, if not completely avoids, the buildup of material and substantially reduces, if not avoids, the need to shutdown a calciner to clean the gas distribution plate of the calciner device. Such a mechanism also preferably permits an increase in the production rate of a calciner device so that the calcination rate of material is not only limited by an initial design of the gas distribution plate and a calcining vessel portion of the calciner device.

### SUMMARY OF THE INVENTION

A calciner device is provided that includes a vertically extending conduit, a gas distribution plate positioned in the vertically extending conduit, and a bypass mechanism connected to the vertically extending conduit. The vertically extending conduit has at least one expanded portion. The gas distribution plate may have a plurality of openings and may be positioned in the vertically extending conduit at a first position. The bypass mechanism may include a bypass conduit that has a first end and a second end, the second end may be positioned upstream of the first position. The second end of the bypass conduit may be connected to the vertically extending conduit such that gas is passable into the expanded portion of the vertically extending conduit via the bypass conduit without passing through the openings of the gas distribution plate.

It should be appreciated that an expanded portion of the vertically extending conduit may be sized and configured so that the reduction in velocity of gas provided by the expanded portion suspends material within the expanded portion for a desired residence time so that the material may be sufficiently calcined. Preferably, the material is suspended in the expanded portion and resides therein until the material is completely calcined.

In some embodiments of the calciner device, the first end of the bypass conduit may be below the second end of the bypass conduit and below the position of the gas distribution plate. The second end of the bypass conduit may be above the gas distribution plate and above the first end of the bypass conduit. An intermediate portion of the bypass conduit may be positioned above the second end of the bypass conduit and include a bent portion that extends down and towards the second end of the bypass conduit.

The calciner device may be a kiln in some embodiments. The kiln may be utilized for the manufacturing of cement or other materials.

Embodiments of the bypass mechanism may also preferably include a valve connected to the bypass conduit and a damper control connected to the valve to adjust the position of the valve for controlling gas flowing through the bypass conduit. The valve is preferably a buttery fly valve. The damper control is preferably configured to control the valve to control a flow rate of gas passing into the expanded portion of vertical conduit adjacent to a gas distribution plate. The damper control may also be configured to ensure sufficient heat is provided via gas fed through the bypass conduit to calcine material suspended in the expanded portion.

The gas distribution plate may be configured to be positioned perpendicular to the flow of gas passing through the openings of the gas distribution plate. For instance, the top surface and bottom surface of the gas distribution plate may be horizontally oriented and be positioned perpendicular to the flow of gas passing through the openings. Of course, the horizontal bottom and top surfaces may also be perpendicular to the vertical direction.

In some embodiments of the calciner device, the first end of the bypass conduit may be connected to a conduit having expelled gas from a device that expels heated gas or may be otherwise connected to a device that expels heated gas, such as a furnace or reactor.

A calciner device is also provided that includes a column defining a conduit for material and gas to pass through. A gas distribution plate is connected to the column at a first position. A bypass mechanism is connected to the column as well. The bypass mechanism includes a bypass conduit that has a first end positioned below the first position and a second end positioned above the first position. The second end of the bypass conduit is connected to the column so that gas is passable into the conduit defined by the column via the bypass conduit without passing through the openings of the gas distribution plate.

The gas distribution plate may be a grid plate or an air distribution plate, for example. The gas distribution plate may have any of a number of shapes, such as a circular shape or polygonal shape, such as rectangular in shape, hexagonal in shape, or octagonal in shape.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of calciner gas distribution plate buildup prevention mechanisms and methods of making and using the same are shown in the accompanying drawings.

FIG. 1 is a perspective view of a gas distribution plate in a calciner that has experienced an undesirable amount of buildup of material.

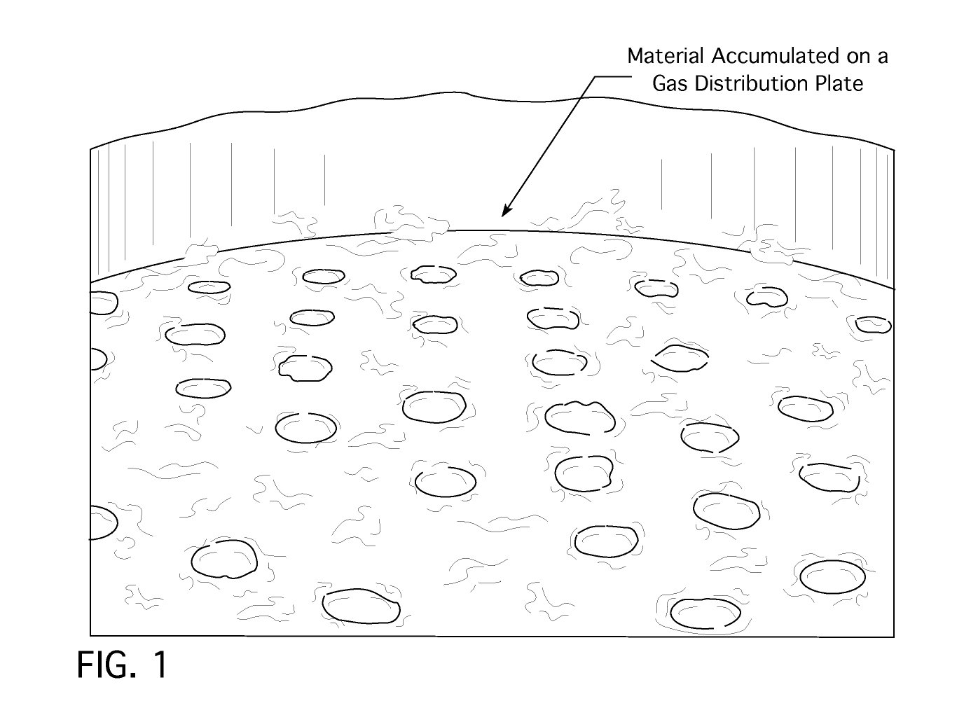

FIG. 2 is front perspective view of a first present preferred embodiment of a calciner gas distribution plate buildup bypass mechanism.

FIG. 3 is a side perspective view of the first present preferred embodiment of a calciner gas distribution plate buildup bypass mechanism.

FIG. 4 is a cross sectional view of the first present preferred embodiment of a calciner gas distribution plate buildup bypass mechanism.

FIG. 5 is a perspective view of a first present preferred embodiment of a calciner that includes an embodiment of a calciner gas distribution plate buildup bypass mechanism

FIG. 6 is a fragmentary perspective view of the first present preferred embodiment of a calciner that includes a calciner gas distribution plate buildup bypass mechanism that illustrates a present preferred butterfly valve connected to a damper control.

### DETAILED DESCRIPTION OF PRESENT PREFERRED EMBODIMENTS

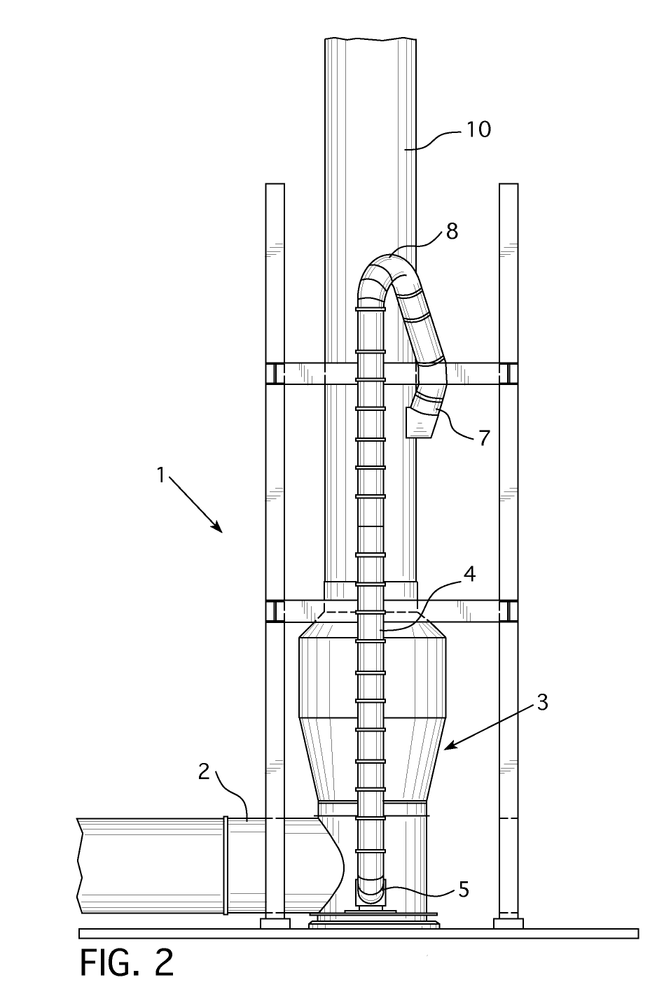

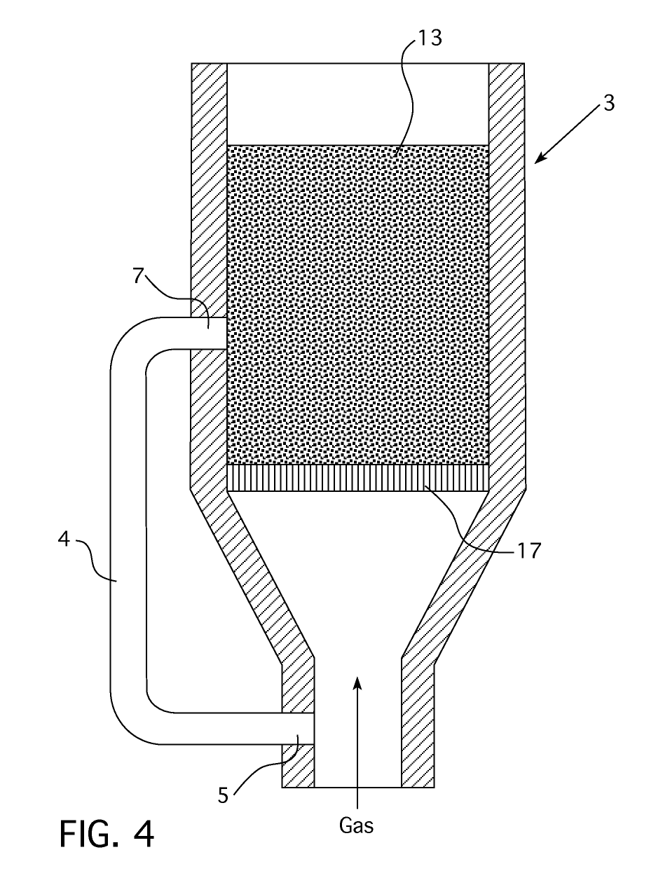

Referring to FIGS. 2-4 a calciner 1 may include a conduit 2 for providing heated gas for calcining material fed to the calciner. The heated gas may be, for example, off gas or exhaust from a furnace, reactor, or other heating generating device that expels or outputs heated gas. The heated gas may be fed into a generally vertical conduit 10 for passing the gas through a gas distribution plate, such as a grid plate 17, which is located below an expanded portion 3 of the vertical conduit 10. The expanded portion 3 is sized and configured to have differing widths to help produce a reduction in velocity for the gas flowing through the expanded portion 3 of the vertical conduit 10. The reduced velocity within the expanded portion may increase the residence time of material suspended in that expanded portion 3. The increased residence time is preferably designed to ensure complete or mostly complete calcination of material suspended in the expanded portion so that the material that flows out of the expanded portion 3 is completely calcined.

Preferably, the grid plate has a plurality of holes or openings that are sized and configured to provide an even distribution of gas flow through the vertical conduit 10 at sufficient velocity to prevent the material to be calcined from passing through the grid plate. It should be understood that the vertical conduit may be a vertical column or may be a portion of a kiln or calciner that is oriented to extend vertically such as extending in a generally vertical direction or in a substantially vertical direction.

A bypass conduit 4 may be connected to the vertical conduit 10 at a position below the grid plate 17 and may extend to a position above the grid plate 17 that feeds heated gas into the expanded portion 3 of the vertical conduit 10. The bypass conduit 4 may have a lower end 5 connected at a position adjacent to an off gas conduit 2 and may have an upper end 7 connected to a portion of the vertical conduit above the grid plate 17. The off gas conduit 2 may be a portion of the column of which the vertical conduit 10 is a part. In alternative embodiments, it is contemplated that the off gas conduit may be a separate conduit that is not connected to the vertical conduit. The heated off gas passing through the bypass conduit 4 may be exhaust from a reactor or furnace or may be gas expelled from a heat exchanger or other gas heating device. No material may be suspended in the gas passing through the bypass conduit 4.

Preferably, the upper end 7 of the bypass conduit 4 is positioned sufficiently above the grid plate 17, or sufficiently upstream of the grid plate 17 to provide additional energy to the expanded portion 3 of the vertical conduit 10 via heated off gas from the conduit 2 passing through the bypass conduit 4 to provide additional heated gas to the expanded portion 3 without requiring that gas to pass through the grid plate 17. The bypass conduit may permit an increase in the mass of heated gas that can be fed to the expanded portion 3 for improving the production capacity for calcining material in the expanded portion 3 without requiring the heat of the gas fed through the grid plate 17 to be increased to a temperature sufficient to warm material in the calciner adjacent to the calciner plate 17 to a temperature within a “sticky” temperature of impurities within the material 13 being calcined. Such an increase in mass of heated gas may also help increase the amount of material that may be calcined in the expanded portion 3 or may increase the rate at which material may be calcined within the expanded portion 3. While the mass of heated gas fed into the expanded portion 3 may be increased via the bypass conduit 4, the velocity of the gas in the expanded portion may be maintained or may be only slightly raised so that a desired residence time for material in the expanded portion is still achieved.

It should be understood that the “sticky” temperature for the material being calcined is a temperature that is sufficient to at least partially melt material such that the material may stick onto the grid plate 17. For instance, a “sticky temperature” may be at or above a temperature of the gas needed to heat the impurity portion of the feed material above the melting temperature for the impurity portion of the material being calcined, but is below the melting temperature of the non-impurity portion of the material being calcined. For example, if the material to be calcined is Trona (sodium sesquicarbonate) that includes less than 1.0 percent of impurity sodium fluoride (NaF) or sodium chlorine (NaCl). The “sticky temperature” may be a temperature of the gas needed to heat the impurity portion of the feed material adjacent to the grid plate to a temperature of at least 750° C.

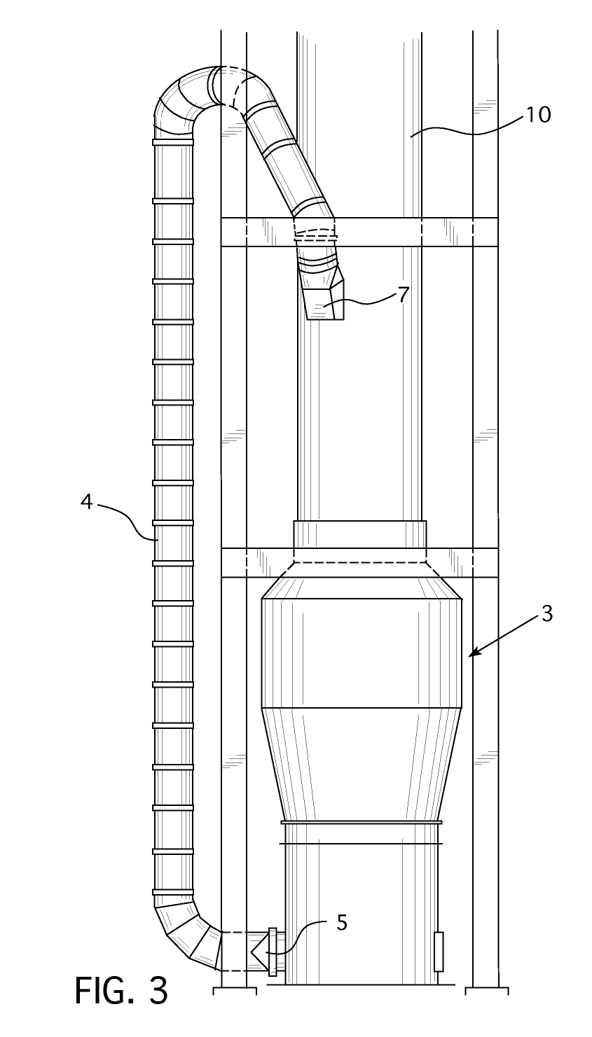

In some embodiments of the calciner gas distribution plate bypass mechanism, the upper end 7 of the bypass conduit may be configured to feed gas via a downwardly facing opening positioned in communication with the expanded portion 3. For instance, the bypass conduit 4 may include an upper intermediate portion 8 that is above the upper end 7 of the bypass conduit 4 such that a portion of the bypass conduit 4 extends from the upper intermediate portion 8 down to the upper end 7 in a curved or bent arrangement as may be seen in FIGS. 2 and 3. The downwardly facing opening of the upper end 7, which is positioned below the intermediate upper portion 8, may prevent material that is in suspension within the expanded portion 3 to fall into the bypass conduit 4.

The upper intermediate portion 8 and downwardly facing end 7 may also permit variable velocities for the gas flowing through the bypass conduit 4 to occur without that flow of gas having to maintain any suspension velocity or carrying velocity for the material in suspension within the expanded portion 3. This permits the gas flowing into the bypass conduit 4 to have an adjustable flow rate. In contrast, the gas flowing through the grid plate is typically not adjustable beyond a range necessary for maintaining particle suspension.

Of course, in other embodiments it is contemplated that such an upper bent portion of the bypass conduit provided by the upper intermediate portion 8 may not be needed or provide an advantage that warrants the additional expense associated with this feature in terms of material costs and additional cost involved in manufacturing and installing this additional length of the bypass conduit 4. In alternative embodiments, it is contemplated that there may be no upper intermediate portion 8 and that only the upper end 7 of the bypass conduit 4 may be configured to face downwardly into an expanded portion to avoid having material that may fall out of suspension pass through the bypass conduit 4.

It should be appreciated that a method of providing or retrofitting a calciner is also provided herein. For instance, a calciner having a vertically extending conduit that includes an expanded portion and has a gas distribution plate attached to it adjacent to the expanded portion may have a bypass mechanism installed or retrofitted thereon. The bypass mechanism may be installed or retrofitted by being connected to the vertically extending conduit. The bypass mechanism may include a bypass conduit that has a first end positioned to receive gas and a second end positioned upstream of the first position to feed gas passing through the bypass conduit into the expanded portion. The second end of the bypass conduit may be connected to the vertically extending conduit such that gas flowing into the vertically extending conduit via the bypass conduit does not pass through the openings of the gas distribution plate.

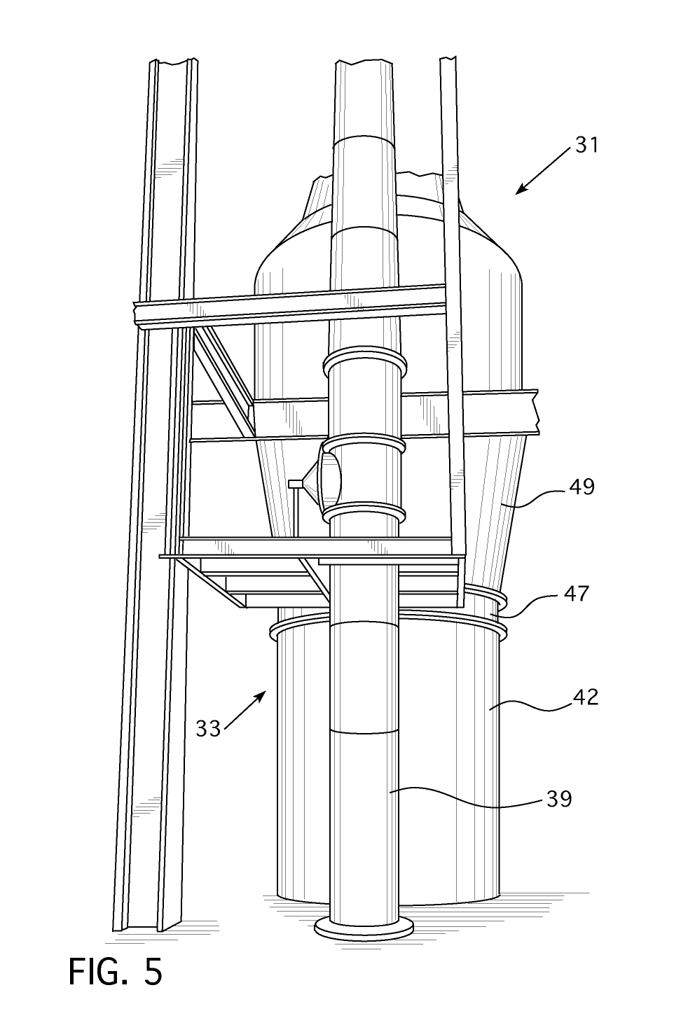

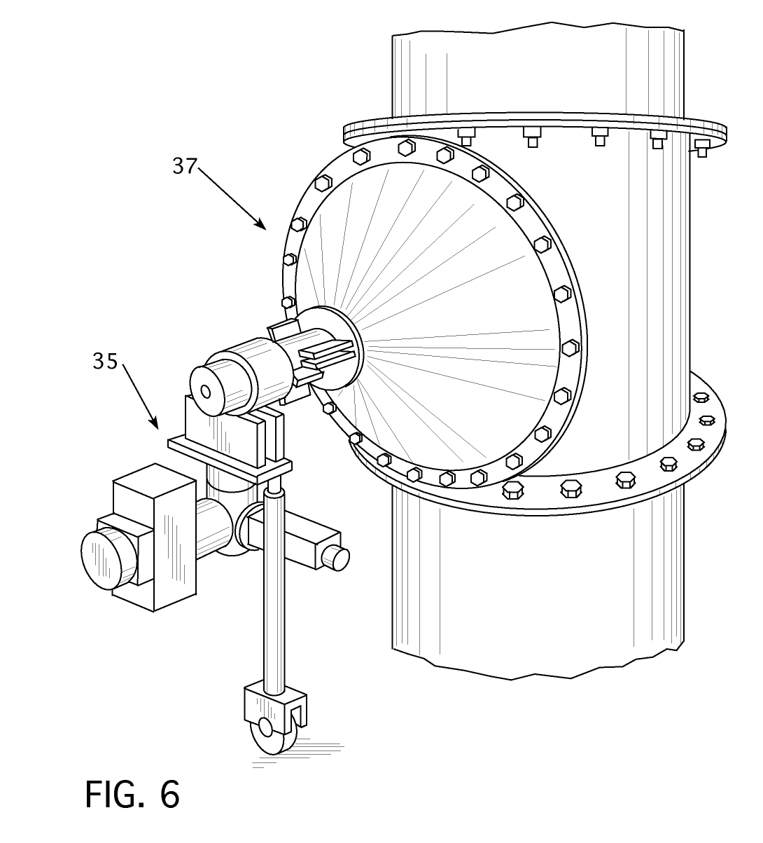

Referring to FIGS. 5 and 6, another embodiment of the calciner gas distribution plate bypass mechanism 33 that may be provided in or connected to a calciner 31 may include a damper control 35 and a valve 37, such as a butterfly valve, quarter-turn valve, or other type of valve. The damper control 35 may be configured to adjust the valve 37 to control or regulate the flow of the gas passing through the bypass conduit 39 and into the vertical conduit 42 upstream from the gas distribution plate, which is positioned at portion 47 of the vertical conduit 42. The vertical conduit 42 may be defined by a vertical column that is composed of piping or other materials or structures for defining the conduit 42. It should be appreciated that expanded portion 49 of the vertical conduit 42 provides a reduction in velocity for the gas flowing through the vertical conduit 42. The decreased velocity increases the residence time for material suspended in the expanded portion 49.

The upper end, or outlet portion of the bypass conduit is positioned upstream of a gas distribution plate located adjacent to the bottom of the expanded portion 49. The bypass conduit is sized and configured to feed gas into the expanded portion without that gas having to pass through the gas distribution plate.

The damper control 35 may be configured to control the flow of gas passing through the bypass conduit 42 to control the amount of heat provided into the expanded portion 49 to control for a rate of calcination for material suspended in the expanded portion 49. Such a damper control may permit the expanded portion to calcine material from between 80% and 120% of the design of the calciner 31 that would not include gas flowing through the bypass mechanism 33.

In contrast, if the bypass mechanism 33 was not utilized, the calcination rate provided by the expanded portion 49 and gas distribution plate would be limited by the volume of gas provided by the design of the expanded portion 49 and fixed gas flow velocity requirement for the gas passing through the gas distribution plate to avoid material fallout. The bypass mechanism may permit as much as a 20% increase in calcine production from an existing column by installing such a bypass mechanism in an existing calciner column. Of course, it is contemplated that some embodiments of the bypass mechanism may event permit greater than a 20% increase in calcination production for an existing calciner that does not include a bypass mechanism and is limited by the gas distribution plate design.

It is contemplated that the damper control 35 could also be or could alternatively be configured to control for other parameters. For instance, the damper control 35 could be configured to adjust the flow rate of gas passing through the bypass conduit upon a detected material calcination rate or a detected temperature of gas at a position in the vertical column 42.

The temperature for the gas passing through the gas distribution plate and adjacent to the gas distribution plate via the bypass conduit is preferably below the melting temperature for the impurities of the impurity portion of the feed material that is also below the melting temperature for the base material of the feed material. Such a temperature determination may be made using conventional calculations for heat transport phenomena and melting temperatures for materials that are known to those of ordinary skill in the art and that are routinely done to design calciners or manage the operation of calciners.

Alternatively, the damper control 35 may be configured to control a flow rate of gas passing into the expanded portion for calcining material to a desired set point rate or to a desire rate for a particular production cycle for calcining a particular batch of material fed to the calciner.

It should also be understood that any number of feed materials that include any number of different types of impurities may be utilized in embodiments of the calciner. Use of feed materials having different impurity levels or variations in impurity contents are generally common in the art and those of ordinary skill in the art may determine a “sticky temperature” for a given composition of feed material as being the lowest melting point temperature for the impurities that may be within the feed material, or may be the lowest melting point temperature for any material that is within the feed material being calcined.

A temperature for use as a set point to control the temperature of the gas passing through the gas distribution plate via the damper control may be utilized that is below a determined “sticky temperature” to ensure that the temperature of the gas passing through and adjacent to the air distribution is low enough to keep material adjacent to the gas distribution plate below its “sticky temperature” for most or all impurities in the feed material that is processed by the calciner. The additional heat provided by the gas passing through the bypass conduit 39 provides additional heat needed for calcining the material without providing heat near the gas distribution plate that could melt material adjacent to the gas distribution plate.

It should be appreciated that embodiments of the gas distribution plate bypass mechanism may permit calciners to be designed so that calcination rates for materials are not limited to the initial design requirements offered by a gas distribution plate and expanded portions of calciner columns. Instead, embodiments of the bypass mechanism may permit calciners to have greater rates of material calcination by providing additional heated gas into the calciner via the bypass mechanism. Such a mechanism may avoid a need for a calciner to be operated at temperature conditions that are at or above a material sticky temperature to obtain an increase in calcination rate that could also lead to material buildup and increased maintenance costs. Such a prevention or reduction of material buildup may reduce costs associated with maintaining the calciner by greatly reducing, if not eliminating, the need to clean or replace the gas distribution plate due to material buildup issues while also increasing production results obtained by the calciner 31.

It should be appreciated that embodiments of the calciner 31 may be used in the manufacture of cement or may be used during the manufacture of other materials. For instance, embodiments of the calciner may be utilized as kilns or in connection with kilns.

It should be understood that embodiments of the damper control may be configured to adjust a the valve 37 to permit more or less heated gas to bypass the gas distribution plate depending on measurements made by different detectors, such as thermostats, thermocouples, gas flow measuring devices, gas flow sensors, or other sensors. Wiring or other connector mechanisms may interconnect the sensors or detectors to the damper control 35.

The damper control 35 may be configured to adjust the valve 37 based on the information transmitted by the sensors or detectors. For instance, if a flow rate of the gas stream is determined to be too low, the damper may be configured to open the valve 37 so that more gas passes through the bypass conduit 39. If the temperature of the gas stream is determined to be higher than a desired set point, the damper control 35 may be configured to send a signal to adjust the valve 37 to a position that partially closes the valve 37 or further closes the valve 37 so less gas flows through the vertical conduit 42 and the expanded portion of the vertical conduit. An automated process control application may be utilized to help oversee the operation of the damper control 35, valve 37 and other components of the calciner 31 or bypass mechanism 33.

It should be appreciated that a number of different variations are possible to the above discussed embodiments. For instance, a calciner device may have multiple expanded portions in a particular column. As another example, a calciner device may be utilized to calcine any of a number of different materials for use in the materials industry or the cement industry. As should be appreciated by those of at least ordinary skill in the art, those materials may use any of a number of different sources for feed material and may include any number of different impurities or impurity concentrations within the feed material.

While certain present preferred embodiments of the calciner air distribution plate buildup prevention mechanism are shown and described and methods of making and using the same have been shown and described above, it is to be distinctly understood that the invention is not limited thereto but may be otherwise variously embodied and practiced within the scope of the following claims.

What is claimed is:

1. A calciner device comprising:
a vertically extending conduit, the vertically extending conduit having an expanded portion;
a gas distribution plate having a plurality of openings, the gas distribution plate positioned in the vertically extending conduit at a first position adjacent to the expanded portion of the vertically extending conduit;
a bypass mechanism connected to the vertically extending conduit, the bypass mechanism comprising a bypass conduit that has a first end positioned to receive gas and a second end positioned upstream of the first position to feed gas passing through the bypass conduit into the expanded portion, the second end of the bypass conduit connected to the vertically extending conduit such that gas flowing into the vertically extending conduit via the bypass conduit does not pass through the openings of the gas distribution plate.

2. The calciner device of claim 1 wherein the vertically extending conduit extends in a perfectly vertical direction or in a direction that is substantially vertical.

3. The calciner device of claim 1 wherein the calciner device is a kiln and wherein the expanded portion is configured to reduce gas velocity after the gas passes through the gas distribution plate.

4. The calciner device of claim 1 wherein the bypass mechanism is also comprised of a valve connected to the bypass conduit between the first end of the bypass conduit and the second end of the bypass conduit.

5. The calciner device of claim 4 wherein the bypass mechanism is further comprised of a damper control connected to the valve to control a flow rate of gas moving from the bypass conduit into the expanded portion.

6. The calciner device of claim 5 wherein the damper control controls the flow rate of the gas such that material in the expanded portion adjacent to the gas distribution plate is not heated to a temperature that is higher than a melting point temperature for that material.

7. The calciner device of claim 6 wherein the melting point temperature is a sticky temperature of the material.

8. The calciner device of claim 6 wherein the material has a base portion and at least one impurity portion and the melting point temperature is a melting point one of the impurity portions of the material.

9. The calciner device of claim 1 wherein the vertically extending conduit is sized and configured for a gas stream having particles of material suspended therein flowing in a vertical direction therein and wherein the gas distribution plate is positioned in the vertically extending conduit such that an upper surface of the gas distribution plate and a bottom surface of the gas distribution plate are positioned perpendicular to the vertical direction in which the gas stream flows.

10. The calciner device of claim 1 wherein the bypass conduit has an upper intermediate portion positioned above the second end of the bypass conduit such that a portion of the bypass conduit extends downwardly from the upper intermediate portion to the second end of the bypass conduit.

11. The calciner device of claim 1 wherein the first end of the bypass conduit is connected to a conduit having expelled gas from a device that expels heated gas, the conduit having expelled gas from the device that expels heated gas being connected to the vertically extending conduit.

12. The calciner device of claim 1 wherein the first end of the bypass conduit is connected to a device that expels heated gas.

13. The calciner device of claim 1 wherein the first end of the bypass conduit is positioned below the gas distribution plate and the second end is positioned above the gas distribution plate and is sized and configured so that an opening for the gas flowing into the expanded portion flows downwardly into the expanded portion.

14. A calciner device comprising:
a column, the column having an expanded portion in which gas and material suspended in the gas passes;
a gas distribution plate having a plurality of openings, the gas distribution plate positioned in the column at a first position;
a bypass mechanism connected to the column, the bypass mechanism comprising a bypass conduit that has a first end positioned below the first position and a second end positioned above the first end and above the first position, the second end of the bypass conduit connected to the column such that gas is passable into the column via the bypass conduit without passing through the openings of the gas distribution plate.

15. The calciner device of claim 14 wherein the bypass mechanism is also comprised of a valve connected to the bypass conduit between the first end of the bypass conduit and the second end of the bypass conduit.

16. The calciner device of claim 15 wherein the bypass mechanism is further comprised of a damper control connected to the valve.

17. The calciner device of claim 14 wherein the calciner device is a kiln.

18. The calciner device of claim 14 wherein the gas distribution plate is a grid plate or an air distribution plate.

19. The calciner device of claim 14 wherein the second end is positioned such that gas is passable into the expanded portion via the bypass conduit without passing through the openings of the gas distribution plate.
